(19) United States
(12) Patent Application Publication
(10) Pub. No.: US 2007/0205670 A1
(43) Pub. Date: Sep. 6, 2007

(54) Method and apparatus for generating multiway and forming multiway switch group

(75) Inventor: Kun-woo Chang, Yangcheon-gu (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/656,401

(22) Filed: Jan. 23, 2007

(30) Foreign Application Priority Data
Mar. 3, 2006 (KR) 10-2006-0020615

(51) Int. Cl. B23K 11/24

(52) U.S. Cl. 307/112

(57) ABSTRACT

An apparatus for generating a multiway packet is provided. The apparatus includes a setting module that sets a multiway switch group by selecting multiple switches; a packet-generating module that generates a data packet according to the set multiway switch group; and a transmission module that transmits the generated data packet to the multiple switches.

### CROSS-REFERENCE TO RELATED APPLICATION

This application is based on and claims priority from Korean Patent Application No. 10-2006-0020615 filed on Mar. 3, 2006 in the Korean Intellectual Property Office, the disclosure of which is incorporated herein in its entirety by reference.

### BACKGROUND OF THE INVENTION

1. Field of the Invention

Methods and apparatuses consistent with the present invention relate to generating a multiway packet and forming a multiway switch group. More particularly, the present invention relates to a method and apparatus that generates a multiway packet and forms a multiway switch group, in which a multiway switch group is formed via software and a slave switch is operated using a multiway method.

2. Description of the Related Art

A home network is a high technology that makes person-to-person, person-to-appliance, and appliance-to-appliance communication possible by connecting electronic appliances through a network, thereby conveniently controlling the appliances and providing various information and services.

Recently, electronic appliances such as TVs and refrigerators are being developing into information appliances through data exchange between the appliances, and electronic appliances using power line communication (PLC) are being introduced so that network appliances, lighting, conventional appliances, and others can be remotely controlled using a mobile phone or the Internet.

PLC refers to a technology that enables communication through the power line already existing in homes, instead of other dedicated communication lines. PLC loads high frequency signals of 100 KHz-100 MHz on the power line for communication, and because all households have a power line, it can be easily installed without requiring the installation of a separate line, which is advantageous. In other words, communication is possible by plugging in the power cord of the device.

Further, PLC was originally developed for controlling electronic appliances based on low-speed communication, but recently, since a high-speed PLC technology has been developed, a high-speed Internet service that uses the existing communication network has been provided, and automatic meter reading for electricity, water and gas is possible. Further, a home network, electronic appliances, and power network management are possible, and especially, a high-speed technology using PLC and a low-speed control technology via a home network are attracting attention as new communication technologies.

Generally, the PLC consists of a modem, a coupler, and a router. The modem modulates and demodulates electric signals of electronic appliances such as the PC and the TV into communication signals. The coupler bypasses an electricity meter in an indoor cabinet panel and distributes communication signals. The router is installed in order to connect with an Internet backbone network.

Households, which use 220 V or 110 V AC, are supplied power through an outlet via an indoor cabinet panel. In other words, a modem is connected to an outlet by a plug, which is connected to a gateway located in the cabinet panel, which is connected to Internet backbone via a router located in a transformer, by which Internet connection is possible.

Here, the router is connected to the backbone network, and transmits data packets to the gateway located in the cabinet panel using the power line. The gateway repeats signals transmitted from the router, and switches the signals to several outlets inside the home. Hence, a home network is possible by plugging a modem into a wall outlet.

FIG. 1 illustrates a physical connection of a PLC-type 3-way lighting switches according to the conventional art.

For example, in the case of multiway-type 3-way lighting switches (hereinafter, also called “switches”), when each switch moves to the upper or lower side, if both switches are positioned in the same direction, the circuit is connected, and the light is turned on.

A 3-way lighting switch 10 includes contacts 11, 12 and 13, and another 3-way lighting switch 20 includes contacts 21, 22 and 23. In other words there are two 3-way lighting switches having 3 contacts.

Here, the contact 12 touches the contact 11 or the contact 13. Likewise, the contact 22 touches the contact 21 or the contact 23. As a result, the light can be turn on or off by both switches. In other words, if each switch is positioned in the same direction, the circuit is connected, thereby turning the light on, and if the switches are positioned in different directions, the circuit is not connected, thereby turning the light off.

For example, in a home where the first floor and the second floor are connected by stairs, and 3-way lighting switches exist on the first floor and the second floor, a user can turn the light on the second floor using the lighting switch 10 on the first floor, and can turn the light off using the second lighting switch 20 on the second floor. Likewise, the user can turn the light on using the lighting switch 20 on the second floor, and can turn the light off on the first floor using the lighting switch 10 on the first floor.

A PLC-type 3-way lighting switch, which uses a Dual In-line Package (DIP) switch and the afore-mentioned principle, is described with reference to FIG. 2.

FIG. 2 illustrates a physical connection of a PLC-type 3-way lighting switch that uses the DIP switch according to the conventional art.

For example, a plurality of 3-way lighting switches, which use PLC in the same logical area, perform a multiway operation so that the same command can be accepted through the DIP-switch setting.

If the user turns the switch on or off, the same command is accepted through the DIP-switch setting, thereby turning the light on or off Here, the command can be transmitted via a gateway, and a plurality of lighting switches can be used by registering the switches in the gateway as the same logical domain.

Further, in order to change the setting value of the command, the setting of the DIP switch should be changed, and the slave switch, where the modem has not been set, cannot set the multiway. Hence, in the case where all multiway switches should be installed in one cabinet panel, because switches having a master-type modem should be installed, there is a need to reduce cost.

Further, for example, if a command is transmitted to a first master switch that includes a first DIP switch 31, the first master switch receives the command and re-broadcasts the command, and a second master switch, which includes a second DIP switch 41, receives the command through the broadcasting and re-broadcasts the command. Hence, if a command of the multiway switch has been performed, multiple switches all accept the command as their own command and broadcast it, and thus an error in operation because of data packet traffic and others can occur.

Further, in a home where the first floor and the second floor are connected by stairs, and there is a PLC lighting switch on the first floor and the second floor, and lighting on the second floor, in the case where another lighting switch is installed in a room, the amount of wiring can become excessive because of the need to connect the lighting switch to a circuit, and in the case where several switches are included in the same cabinet panel, the circuit becomes complicated, thereby making structural changes difficult.

Further, in the case where installed switches are displayed through the user interface, switch IDs are provided, but the structure of switches is not provided, which is inconvenient.

### SUMMARY OF THE INVENTION

An aspect of the present invention is to provide a method and apparatus for generating a multiway packet and forming a multiway switch group.

The present invention will not be limited to the technical aspects described above. Other aspects not described herein will be more definitely understood by those in the art from the following detailed description.

According to an exemplary embodiment of the present invention, there is provided an apparatus for generating a multiway packet, the apparatus including a setting module that sets a multiway switch group by selecting multiple switches; a packet-generating module that generates a data packet according to the set multiway switch group; and a transmission module that transmits the generated data packet to the multiple switches.

According to an exemplary embodiment of the present invention, there is provided an apparatus for forming a multiway switch group, the apparatus including a receiving module that receives a data packet generated according to the setting of a multiway switch group; a reading module that reads the setting value of the multiway switch group of the data packet; and a forming module that binds multiple switches as a multiway switch group according to the setting value of the read multiway switch group.

According to an exemplary embodiment of the present invention, there is provided a method of generating a multiway packet, the method including setting a multiway switch group by selecting multiple switches; generating a data packet according to the set multiway switch group; and transmitting the generated data packet to the multiple switches.

According to an exemplary embodiment of the present invention, there is provided a method of forming a multiway switch group, the method including receiving a data packet generated according to the setting of a multiway switch group; reading the setting value of the multiway switch group of the data packet; and binding multiple switches as a multiway switch group according to the setting value of the read multiway switch group.

### BRIEF DESCRIPTION OF THE DRAWINGS

The above and other features and aspects of the present invention will become apparent by describing in detail exemplary embodiments thereof with reference to the attached drawings, in which:

FIG. 1 illustrates a physical connection of a power line communications (PLC)-type 3-way lighting switch according to the conventional art.

FIG. 2 illustrates a physical connection of a PLC-type 3-way lighting switch that uses a Dual In-line Package (DIP) switch according to the conventional art.

FIG. 3 is a block diagram of an apparatus for generating a multiway packet according to an exemplary embodiment of the present invention.

FIG. 4 is a block diagram of an apparatus for forming a multiway switch group according to an exemplary embodiment of the present invention.

FIG. 5 is a flow chart of a method of generating a multiway packet according to an exemplary embodiment of the present invention.

FIG. 6 is a flow chart of a method of forming a multiway switch group according to an exemplary embodiment of the present invention.

FIG. 7 illustrates the structure of a multiway switch group according to an exemplary embodiment of the present invention.

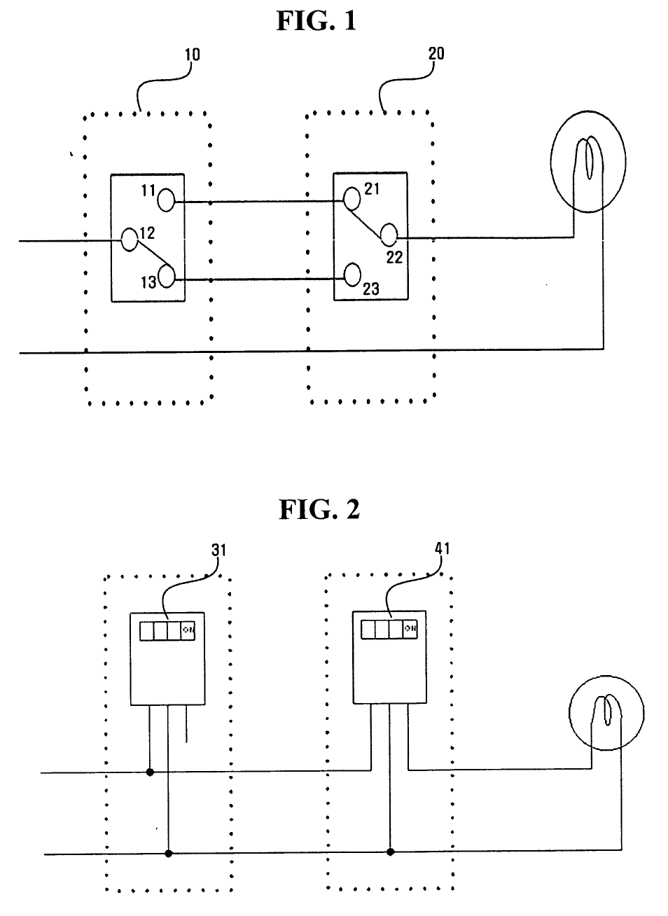

### DETAILED DESCRIPTION OF THE INVENTION

Exemplary embodiments of the present invention will be described in detail with reference to the accompanying drawings.

Aspects and features of the present invention and methods of accomplishing the same may be understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

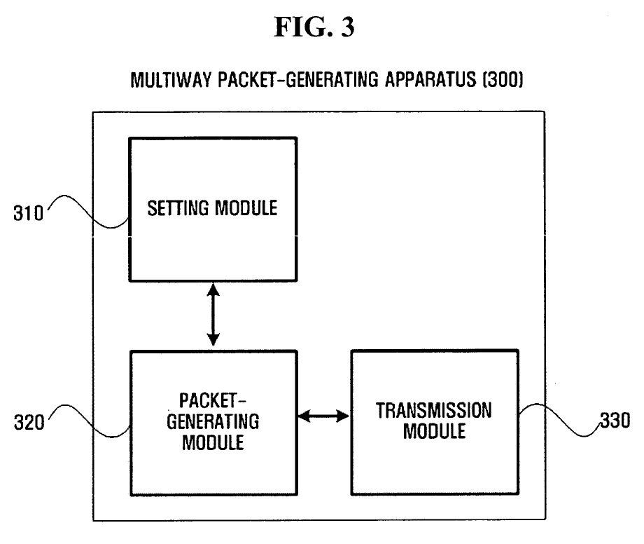

FIG. 3 is a block diagram of an apparatus for generating a multiway packet according to an exemplary embodiment of the present invention.

A multiway-packet-generating apparatus 300 includes a setting module 310, a packet-generating module 320, and a transmission module 330. The multiway-packet-generating apparatus 300 can be included in a gateway.

The setting module 310 selects multiple switches, and sets a multiway switch group. In the case where a load (lighting) is not connected to a predetermined switch bound to the multiway switch group, when receiving a command from another switch, it is not repeatedly broadcast by registering its own state through the setting module 310, and thus an error in the switch operation because of the traffic of the data packet can be prevented.

In the multiway switch group setting, a user can see the list of multiple switches logically registered in the gateway through the user interface (UI) screen. Further, the multiway switch group set through the setting module 310 is provided to the user through the UI screen, and the UI screen can display by multiway switch groups. The UI screen can be provided using various languages such as XML or HTML, and switches in the multiway switch group can be conveniently released through the setting module 310.

For example, in a home where there is a first master switch on the first floor, there are a second master switch and a second slave switch on the second floor, and there is a third master switch in an inner room, a user can bind the first master switch on the first floor and the second master switch on the second floor as a multiway switch group (e.g., a 3-way lighting switch), and can bind the second slave switch on the second floor and the third master switch in the inner room as a multiway switch group. Here, the master switch refers to a main switch that has a communication modem that can communicated with a gateway and other switches (e.g., a slave switch); the slave switch refers to a multiway-type switch bound to the master switch. Hence, in a 3-way lighting switch operation type, a user can turn on the first lighting using the first master switch on the first floor, and can turn off the first lighting using the second master switch on the second floor. Further, the user can turn on the second lighting using the second slave switch on the second floor, and can turn off the second lighting using the third switch in the inner room. The on and off states between the switches can also be operated in reverse order.

Further, in the case where there is a switch to be released within a multiway switch group, the user can release the switch in the multiway switch group via the UI screen, and in order to apply it, a data packet is generated by the packet-generating module 320, and is then transmitted.

The packet-generating module 320 generates a data packet according to the multiway switch group set through the setting module 310.

The data packet includes a header field, a master field, an extension field, and a data field. In the case of the header, an ID, which can distinguish each master switch and slave switch, can be set. For example, the first master switch can be set as 1, and the two slave switches bound to the first master switch can be set as 1-1 and 1-2, respectively. Further, by using binary numbers for the field values of the data packet, the master switch can be set via the master field, and the slave switch bound to the master switch can be set via the extension field. For example, in the case where one first master switch and two second slave switches are bound as a multiway switch group, the first master switch can be granted the master field 0001, and the second slave switches can be granted the slave fields 0010 and 0011. The binary number value is merely exemplary and various values such as hexadecimal numbers can be used depending on the structure. Further, the data field can include an address of each switch, registration information of each switch, checksum, and other information. For example, the data field can include estate information such as the case where a load (lighting) is not connected to a predetermined switch.

The transmission module 330 transmits a data packet generated according to the setting of the multiway switch group to multiple switches. Here, the data packet, which is a Common Gateway Interface (CGI)-type value, can be transmitted to the multiple switches via a gateway, and the data packet can be transmitted via power line communications (PLC), wireless communication, or serial communication.

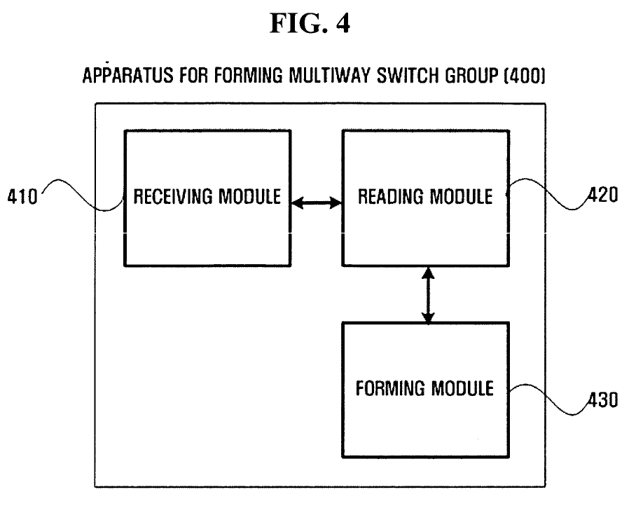

FIG. 4 is a block diagram of an apparatus for forming a multiway switch group according to an exemplary embodiment of the present invention.

A multiway-switch-group-forming apparatus 400 includes a receiving module 410, a reading module 420, and a forming module 430. The multiway-switch-group-forming apparatus 400 can be included in each switch.

The receiving module 410 receives a data packet generated by the setting of a multiway switch group. The data packet can be transmitted via power line communications (PLC), wireless communication, or serial communication.

The reading module 420 reads the multiway-switch-group data packet setting value. Here, the reading module 420 can be built in each switch, and can read the setting state of the received multiway switch group via a parser program by operating as a software module that includes software components. Hence, because the multiway switch can be set via software through a software module instead of the Dual In-line Package (DIP) switch type, costs can be reduced, and efficiency can be increased. For reference, according to the conventional art, in the case where the setting of the DIP switch needs to be changed, the slave switch, in which a modem has not been installed, cannot be set as a multiway. Hence, in the case where only multiway switches are set in one cabinet panel, switches, which include a master-type modem, should be set, which increases the cost of the device.

The forming module 430 binds multiple switches as the multiway switch group according to the setting of the read multiway switch group. As such, the slave switch, which is bound to the master switch according to the setting of the multiway switch group, is stored in the memory of the master switch, and is operated as a multiway switch.

Further, in the case where there is a switch to be released from the multiway switch group, the switch can be released from the multiway switch group by reading the data packet.

As mentioned above, because a slave switch, which does not include a modem, can be set as a multiway switch, an expensive master switch is not needed, and thus costs are reduced. Further, this device is more user-friendly because the multiway switch group can be formed via software instead of the DIP switch type.

The term “module”, as used herein, means, but is not limited to, a software or hardware component, such as a Field Programmable Gate Array (FPGA) or an Application Specific Integrated Circuit (ASIC), which performs certain tasks. A module may advantageously be configured to reside in the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules

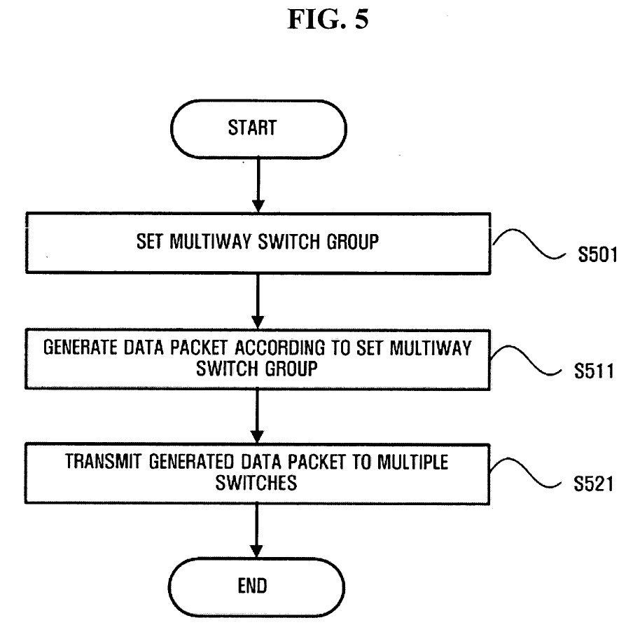

FIG. 5 is a flow chart of a method of generating a multiway packet according to an exemplary embodiment of the present invention.

The user can logically see the list of multiple switches registered in a gateway via the User Interface (UI) screen. Further, the multiway switch group set by the setting module can be provided to the user through the UI screen, and the UI screen can be outputted in a classified state by multiway switch groups. The UI screen can be provided using various languages such as XML or HTML, and switches in the multiway switch group can be conveniently released through the setting module 310.

First, a user selects multiple switches to be connected as multiway switches through the setting module, and sets a multiway switch group S501.

For example, in a home where there is a first master switch on the first floor, a second master switch and a second slave switch on the second floor, and a third master switch in an inner room, a user can bind the first master switch on the first floor and the second master switch on the second floor as a multiway switch group (e.g., a 3-way lighting switch), and can bind the second slave switch on the second floor and the third master switch in the inner room as a multiway switch group. Further in the case where there is a switch to be released in the multiway switch group, the switch can be released from the multiway switch group through the UI screen.

The packet generating module 320 generates a data packet according to the multiway switch group S511.

Next, the transmission module 330 transmits the generated data packet according to the setting of the multiway switch group S521. Here, the data packet, which is a CGI-type value, can be transmitted to the multiple switches via a gateway, and the data packet can be transmitted via power line communications (PLC), wireless communication, or serial communication.

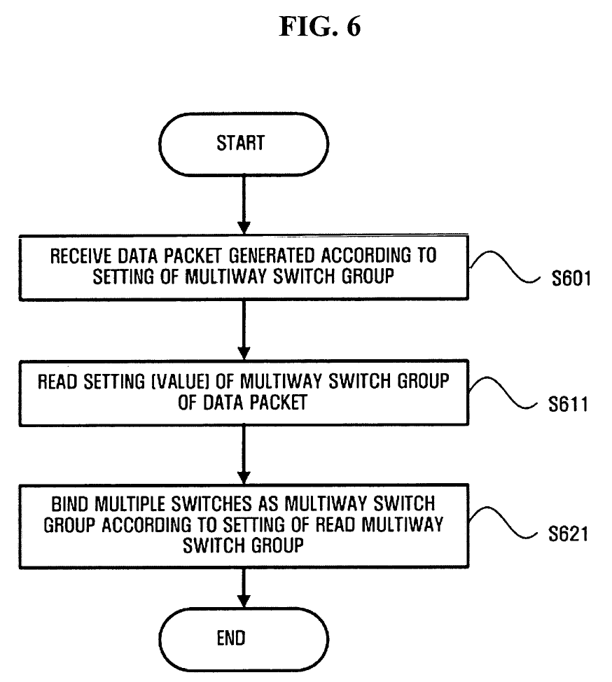

FIG. 6 is a flow chart of a method of forming a multiway switch group according to an exemplary embodiment of the present invention.

A receiving module 410 receives a data packet generated according to the setting of a multiway switch group S601. The data packet can be received via power line communications (PLC), wireless communication, or serial communication.

The reading module 420 reads the multiway-switch-group data packet setting value S611. Here, the reading module 420 can be built in each switch, and can read the setting state of the received multiway switch group via a parser program by operating as a software module that includes software components. Hence, because the multiway switch can be set via software through a software module instead of the Dual In-line Package (DIP) switch type, costs can be reduced, and efficiency can be increased. For reference, according to the conventional art, in the case where the setting of the DIP switch needs to be changed, the slave switch, in which a modem has not been installed, cannot be set as a multiway switch. Hence, in the case where only multiway switches are set in one cabinet panel, switches, which include a master-type modem, should be set, which increases the cost of the device.

The forming module 430 binds multiple switches as the multiway switch group according to the setting of the read multiway switch group S621. As such, the slave switch, which is bound to the master switch according to the setting of the multiway switch group, is stored in the memory of the master switch, and is operated as a multiway switch.

Further, in the case where there is a switch to be released from the multiway switch group, the switch can be released from the multiway switch group by reading the data packet.

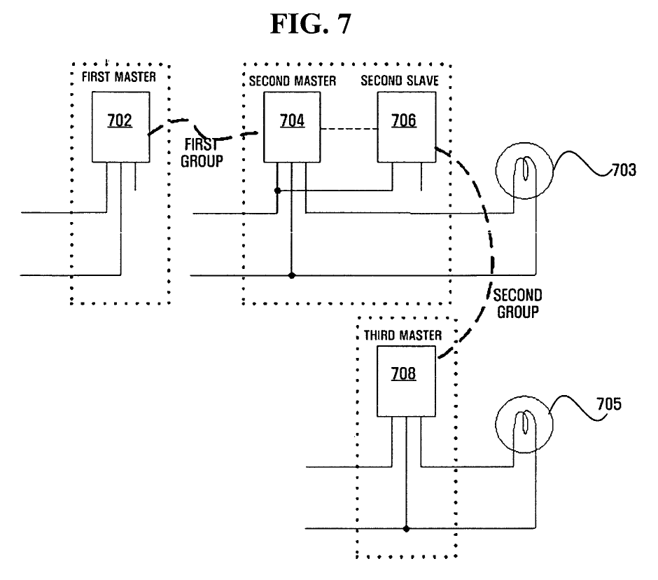

FIG. 7 illustrates the structure of a multiway switch group according to an exemplary embodiment of the present invention.

For example, there is a home where there is a first master switch 702 on the first floor, there are a second master switch 704 and a second slave switch 706 on the second floor, and there is a third master switch 708 in an inner room. Further, there is a first lighting 703 on the first floor and a second lighting 705 on the second floor.

The user wants control the first lighting 703 on the first floor by binding the first master switch 702 and the second master switch 704 on the second floor as a multiway switch group (a first group), and wants to control the second lighting 705 on the second floor by binding the second slave switch 706 on the second floor and the third switch 708 in the inner room as a multiway switch group (a second group). The multiway connection can use a 3-way or 4-way multiway switch method, and others.

The user can see the list of multiple switches logically registered in a gateway through the UI screen, and multiway switch groups can be set by binding switches in the list of multiple switches. The set multiway switch groups are provided to the user through UI screen, and the groups can be outputted in a classified state by switch groups (the first group and the second group).

According to the set multiway switch group, a data packet is generated, and if the packet is transmitted to each switch, a software module included in each switch reads a setting (value) of the multiway switch group from the received data packet. Hence, the master switch changes its own setting as a master within the multiway switch group, and stores the slave switch-bound as the multiway switch group in the memory of the master switch. Here, because the slave switch, which does not have a modem, can be set as a multiway switch, an expensive master switch is not needed, and thus costs are reduced.

In other words, the first master switch 702 and the second master switch 704 on the second floor are bound as a multiway switch group (a first group), and the second slave switch 706 and a third master switch in the inner room are bound as a multiway switch group (a second group).

Hence, the user can turn on the first lighting 703 using the first master switch 702 on the first floor, and can turn off the first lighting 703 using the second master switch 704 on the second floor. Further, the user can turn on the second lighting 705 using the second slave switch 706 on the second floor, and can turn off the second lighting using the third master switch 708 in the inner room. The turning on or off of the switches can be operated in reverse order.

Further, for example, in the case where a lighting (a load) is not connected to the third master switch 708 in the inner room and the second slave switch 706 bound as a multiway switch group, its own state is transmitted to the gateway, and thus a command transmitted from the third master switch 708 is not re-broadcasted, by which an error in switch operation because of traffic of a data packet can be prevented.

It should be understood by those of ordinary skill in the art that various replacements, modifications and changes may be made in the form and details without departing from the spirit and scope of the present invention as defined by the following claims. Therefore, it is to be appreciated that the above described exemplary embodiments are for purposes of illustration only and are not to be construed as limitations of the invention.

The method and apparatus of the present invention has the following aspects.

First, a multiway switch group can be easily formed via software.

Second, a slave switch, which does not include a modem, can be formed as a multiway switch.

Third, costs are reduced and errors in each switch operation are prevented.

What is claimed is:

1. An apparatus for generating a multiway packet, the apparatus comprising:
a setting module that sets a multiway switch group by selecting multiple switches;
a packet-generating module that generates a data packet according to the set multiway switch group; and
a transmission module that transmits the generated data packet to the multiple switches.

2. The apparatus of claim 1, wherein the multiway switch group comprises at least one of a master switch and a slave switch, and is outputted through a user interface (UI) screen in a classified state by groups.

3. The apparatus of claim 2, wherein the data packet is transmitted by power line communication (PLC), wireless communication, or serial communication.

4. An apparatus for forming a multiway switch group, the apparatus comprising:
a receiving module that receives a data packet generated according to a setting value of a multiway switch group;
a reading module that reads the setting value of the multiway switch group of the data packet; and
a forming module that binds multiple switches as the multiway switch group according to the read setting value of the multiway switch group.

5. The apparatus of claim 4, wherein the reading module reads the setting value of the multiway switch group via a parser program.

6. The apparatus of claim 5, wherein the multiway switch group comprises at least one of a master switch and a slave switch, the slave switch bound to the master switch is operated as a multiway switch, and information about the slave switch is stored in a memory of the master switch.

7. A method of generating a multiway packet, the method comprising:
setting a multiway switch group by selecting multiple switches;
generating a data packet according to the set multiway switch group; and
transmitting the generated data packet to the multiple switches.

8. The method of claim 7, wherein the multiway switch group comprises at least one of a master switch and a slave switch, and is outputted through a user interface (UI) screen in a classified state by groups.

9. The method of claim 8, wherein the data packet is transmitted via power line communication (PLC), wireless communication, or serial communication.

10. A method of forming a multiway switch group, the method comprising:
receiving a data packet generated according to a setting value of a multiway switch group;
reading the setting value of the multiway switch group of the data packet; and
binding multiple switches as a multiway switch group according to the read setting value of the multiway switch group.

11. The method of claim 10, wherein the reading reads the setting value of the multiway switch group via a parser program.

12. The method of claim 11, wherein the multiway switch group comprises at least one of a master switch and a slave switch, the slave switch bound to the master switch is operated as a multiway switch, and information about the slave switch is stored in a memory of the master switch.

13. A method of configuring a switch group, the method comprising:
receiving a data packet comprising a switch group information;
reading the switch group information in the received data packet;
binding a first switch of a plurality of switches with a second switch of the plurality of switches in accordance with the switch group information, the first switch having a first state and a second state, and the second switch having a third state and a fourth state;
wherein an operation of the first switch switches an operation of a first device connected to the second switch.
